(19) United States
(12) Patent Application Publication
(10) Pub. No.: US 2008/0164097 A1
(43) Pub. Date: Jul. 10, 2008

(54) Collapsible Combination Ladder

(75) Inventor: Per-Olof Eriksson, Tranas (SE)

Correspondence Address: BREINER & BREINER, L.L.C., P.O. BOX 320160, ALEXANDRIA, VA, 22320-0160, US

(73) Assignee: TELESTEPS AB, TRANAS (SE)

(21) Appl. No.: 11/883,437

(22) PCT Filed: Feb. 1, 2006
(86) PCT No.: PCT/EP06/00856

§ 371 Date: Jul. 31, 2007

(51) Int. Cl. E06C 1/00

(52) U.S. Cl. 182/22

(57) ABSTRACT

A collapsible stepladder (1) comprising two ladder legs (2, 3), where the legs (2, 3) are hingedly connected to each other in one end. Each of the ladder legs (2, 3) comprises several ladder sections (4a-4d), and where each section comprises two ladder bars (6, 7) arranged parallel to each other and interconnected at one end by a rung (8) to form a U-shaped ladder section. The ladder sections are telescopically inserted into a lower ladder section (4e) to form a collapsible ladder comprising at least three ladder sections. One of the ladder legs (3) is provided with a support part (12) in one end. The support part (12) is telescopically extendible from the ladder leg (3) and forms an extension ladder of the ladder leg and where the support part (12) projects above a hinge (5) between the two ladder legs (2, 3).

### FIELD OF THE INVENTION

The present invention relates to a collapsible stepladder provided with ladder sections being telescopically inserted in each other.

### BACKGROUND OF THE INVENTION

Collapsible and expandable stepladders are known in the art. Below examples of prior art are stepladders described.

In WO-A1-99/51848 a telescopically collapsible stepladder is disclosed comprising two legs that are hinged to one another. Each leg is formed of telescopically collapsible sections having latch mechanisms in each of the rungs for automatically locking the sections relative to one another when the leg is extended. The latch mechanisms in each rung are designed to release the next higher section when the rung is collapsed against the next lower rung. The separation of the rungs of one of the legs, when the stepladder is extended, is greater than the separation of the rungs in the other leg. The problem with the stepladder of WO-A1-99/51848 is that the collapsible sections of the two legs have different height, which is why the stepladder will never pass type approval. Further, the stepladder can not be converted to a straight ladder, since folding the two legs to be adjacent, results in a ladder with many small steps due to the different height of collapsible sections.

In U.S. Pat. No. 4,989,692 a ladder including two hinged sections is disclosed, that can be oriented in an inverted V-configuration for use as a stepladder, or in a straight linear configuration for use as a straight ladder. Each section of the ladder includes a number of U-shaped support units, each of which defines a crossbar and two downwardly extending side rails. The side rails of the different U-shaped units are of graduated cross sectional dimensions, so that the units can be contracted together by telescopically sliding the aligned side rails within one another. The problem with the ladder of U.S. Pat. No. 4,989,692 is that the two sections of the ladder can not be used without an external support or the user will need to balance while working, which is not preferable from a work safety aspect. This is due to the lack of support provided on the ladder while using the upper ladder sections of the ladder. Another problem with the ladder is that if the ladder is converted to a straight ladder, the ladder is rather unstable since the two legs are folded up and fixed to each other by a swingable tie bar 26. Such a fixing arrangement is neither very secure, nor is it very stable and would not pass type approval.

In GB-A-2 110 286 another stepladder is disclosed, including a first set of strong and telescopic elements, a second set of parts, each comprising a support surface forming one step of the ladder. Each part is transversely connected to one element or group of strong elements of the first set. A set of stopper studs and locking means between the various strong elements of the first set is arranged to ensure at least the stability of the two extreme positions of the ladder, that is, of the ladder folded up on itself and of the extended ladder. The ladder of GB-A-2 110 286 not only suffers from the same problems as U.S. Pat. No. 4,989,692, but also lacks a locking or fixing arrangement in the converted disposition.

The object of the present invention is to overcome the disadvantages and problems with the prior art stepladders and to provide a stepladder, which is easy and safe to handle and which is possible to convert into a straight ladder without lowering the standards of safety and manageability.

### SUMMARY OF THE INVENTION

A stepladder according to the characterizing features of claim 1 solves the above problem.

The features of the dependent claims define further aspects of the claimed invention and preferred embodiments.

### BRIEF DESCRIPTION OF THE DRAWINGS

In the following, the invention will be explained with reference to the accompanying drawings, wherein:

FIG. 1 is a perspective view of a maximally collapsed stepladder according to the invention;

FIG. 2 is a perspective view of the stepladder according to the invention, where all ladder sections are fully extended;

FIG. 3 is a side view of the stepladder according to the invention, where all ladder sections are fully extended;

FIG. 4 is a perspective view of the ladder according to the invention in a converted style as a straight ladder having one ladder section collapsed;

FIG. 5 is a side view of the ladder according to the invention in a converted style as a straight ladder having one ladder section collapsed;

FIG. 6 is a side view of the stepladder according to the invention provided with a locking device, where all ladder sections are fully extended; and

FIGS. 7-8 are side views of the stepladder according to the invention provided with a locking device, where all ladder sections are completely collapsed.

### DETAILED DESCRIPTION OF THE EMBODIMENTS

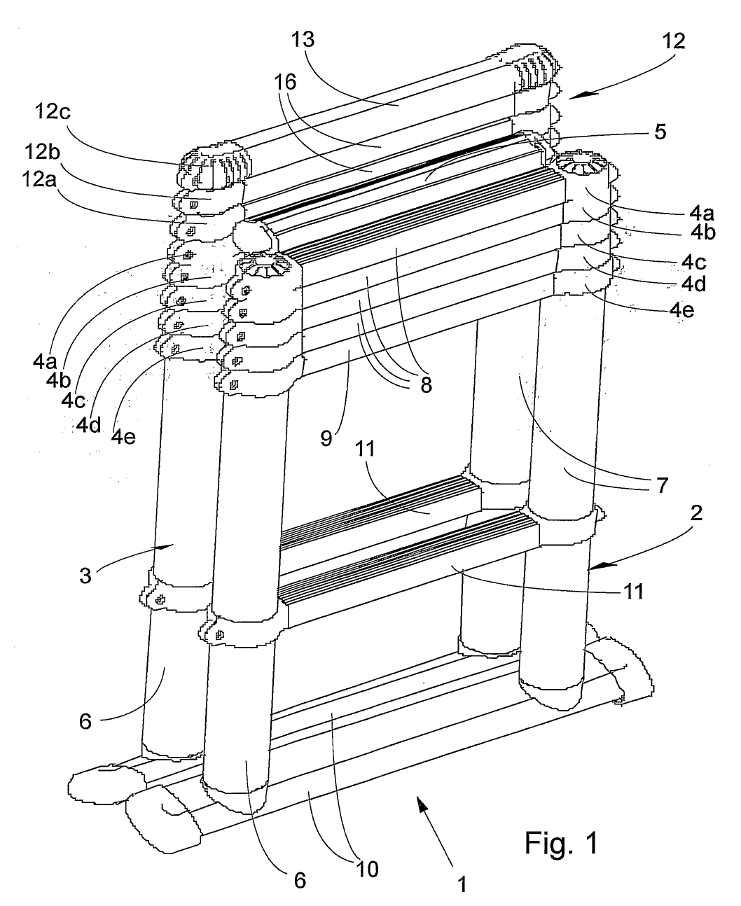

A collapsible stepladder 1 according to the invention is shown in the drawings. FIG. 1 shows a collapsible stepladder 1 comprising a first ladder leg 2, which is hingedly connected to a second ladder leg 3 in the upper ends of the first and second ladder leg 2, 3 by a hinge connection 5. Each of the ladder legs 2, 3 comprise several ladder sections 4a-4d, where each ladder section 4a-4d comprises two ladder bars 6, 7, arranged parallel to each other and interconnected at one end by a rung 8 to form a U-shaped ladder section 4a-4d. The ladder sections 4a-4d are telescopically inserted into a lower ladder section to form a collapsible ladder leg 2, 3. The ladder legs 2, 3 further comprise a lower ladder section 4e, which comprises two ladder bars 6, 7, arranged parallel to each other and interconnected at a upper end by a rung 9, at a lower end by a ladder base 10 and in between the rung 9 and the ladder base 10 by another rung 11. The ladder sections 4a-4d are telescopically inserted into the ladder section 4e.

The ladder legs 2,3 should comprise at least three ladder sections 4a-4e, but in a preferred embodiment four collapsible ladder sections 4a-4d are arranged together with the lower ladder section 4e. The number of ladder sections is limited by the stability of the stepladder and the requirement to pass type approval.

Each rung 8, 9 comprises a retaining mechanism for automatically locking the ladder sections relative to one another when the ladder legs 2,3 are extended. The retaining mechanism could be any kind previously known in the art, e.g. any of the retaining mechanisms shown in EP-B1-0 527 766 or EP-A1-1 402 143.

The second ladder leg 3 is provided with a support part 12 in one end. The support part 12 is telescopically extendible from the second ladder leg 3 to form a ladder extension 12 of the ladder leg 3, and the support part 12 projects above the hinge connection 5 between the two ladder legs 2, 3. The support part 12 comprise at least one support section 12a-12b, each support section comprising two ladder bars 6, 7 arranged parallel to each other and interconnected at one end by a rung 16 to form at least one U-shaped support section 12a-12b. The support sections 12a-12b are telescopically inserted into the ladder leg 3 to form a collapsible support part 12. The support part 12 also comprises an upper support section 12c, comprising two ladder bars 6, 7, arranged parallel to each other and interconnected at one end by a rung 13 to form a U-shaped support section 12c. The support section 12c is telescopically inserted into the lower support section 12a-12b.

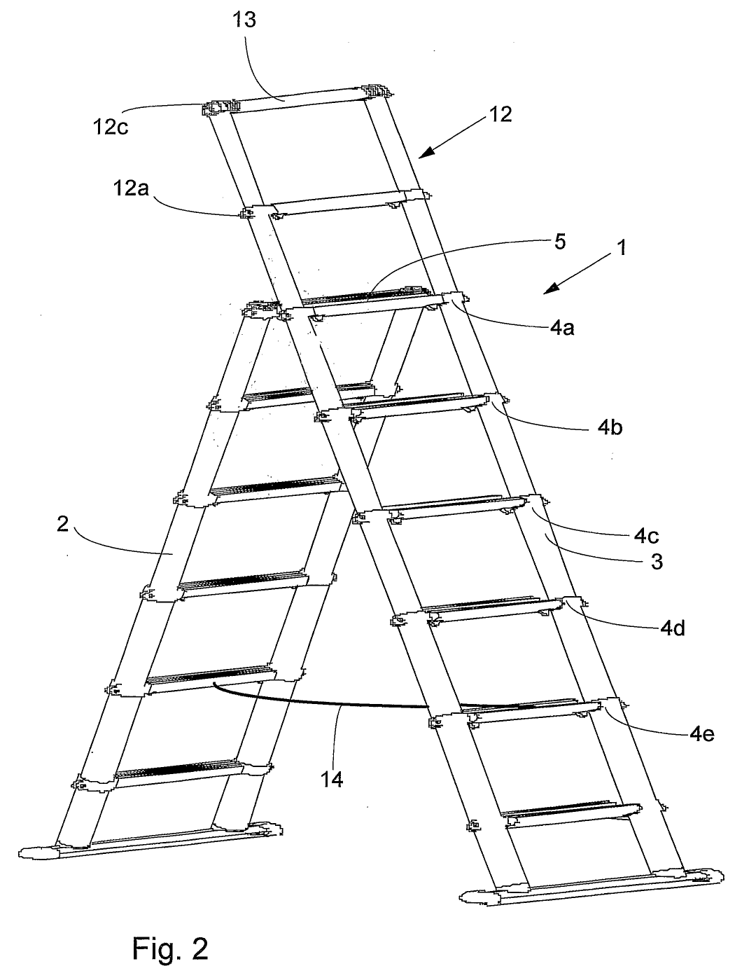

In FIG. 2. the ladder is shown, having both ladder legs 2, 3 and the support or extension part 12 fully extended. The support part 12 enables the user of the stepladder to stand on the upper ladder section 4a-4b as the support part 12 makes the user feel safe. In FIG. 2 the support part 12 comprises two collapsible ladder sections 12a and 12c. On the upper rung 13 of the support part 12, a device for holding tools or objects, such as a tray, a table, a shelf, a box/case or a basket, can be arranged. The device is clamped, squeezed, hanged, hooked or in any other suitable manner arranged to be positioned at the upper rung 13. The rung 13 might be arranged with receiving means such as holes, chamfered surfaces, recesses or the like to better receive the holding device.

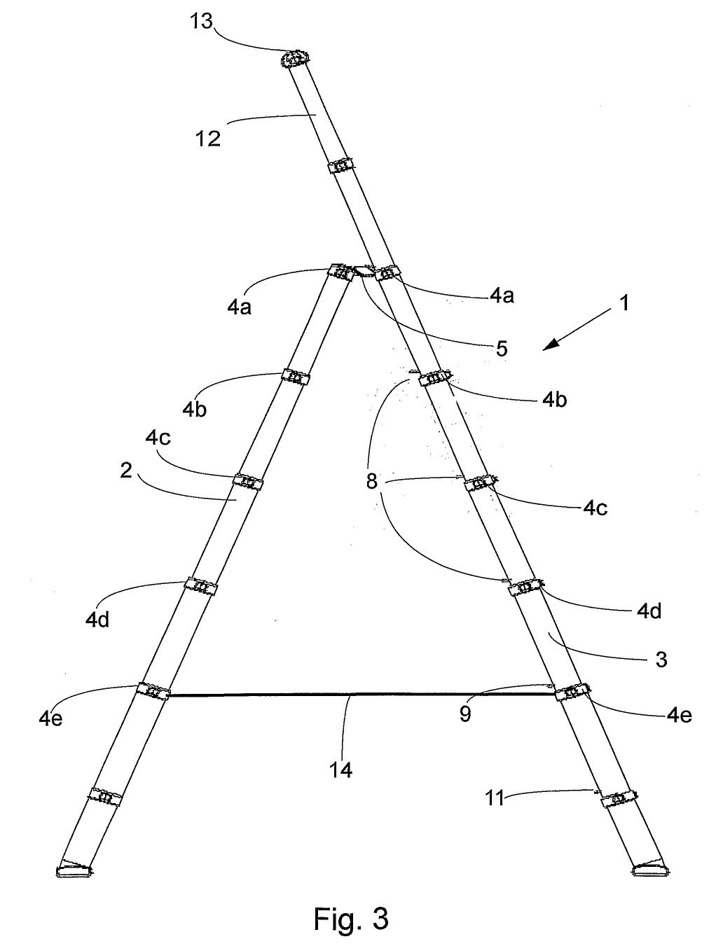

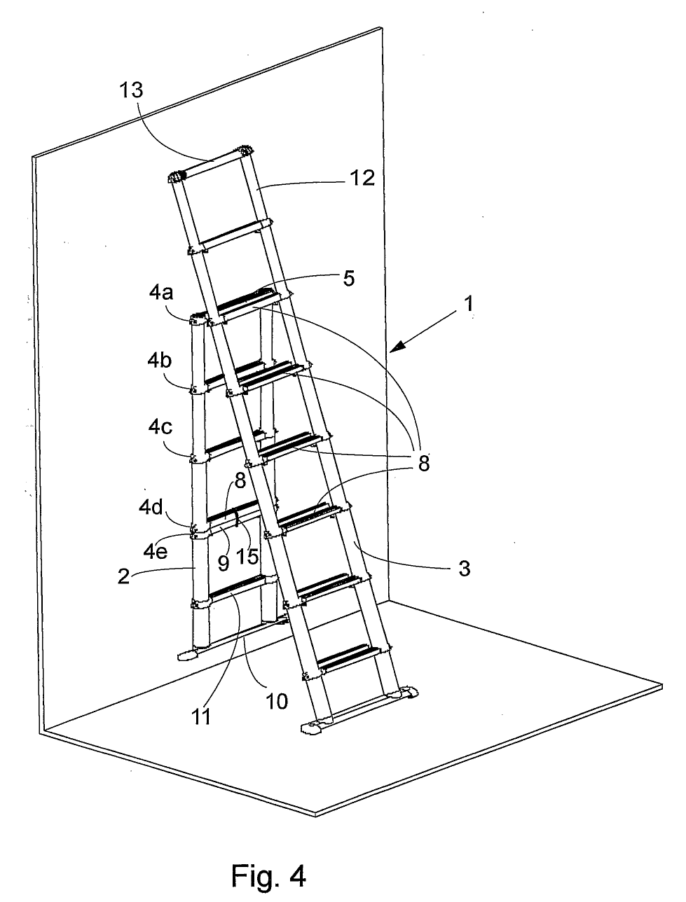

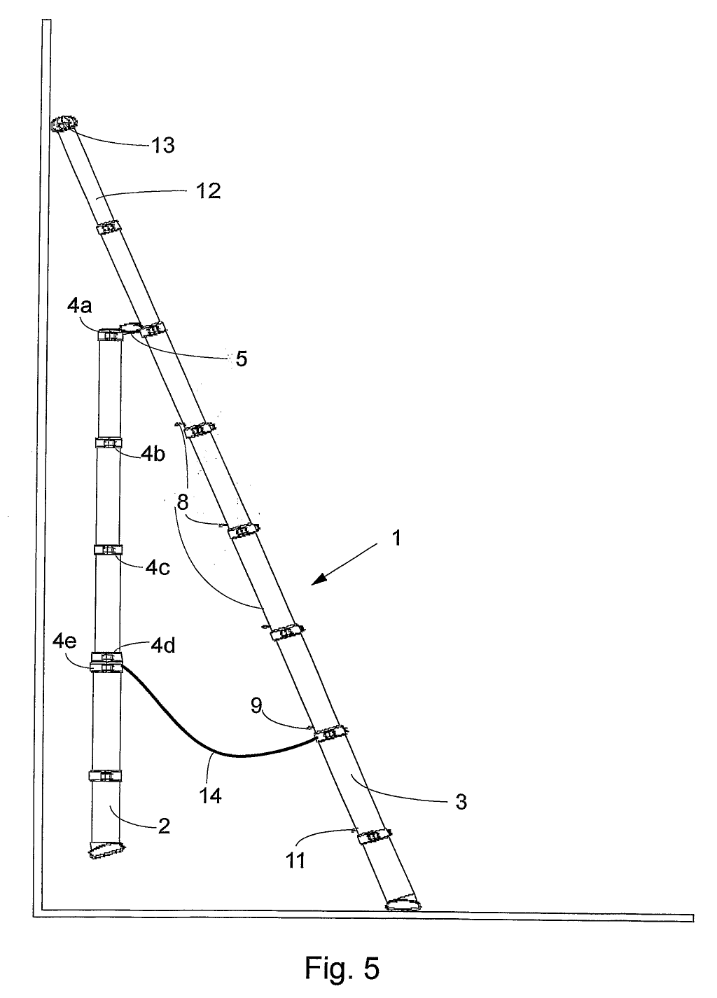

In FIG. 2 a strap 14 is also shown arranged between the ladder legs 2, 3 to increase the stability of the ladder in the extended and folded mode and to prevent the ladder legs from splaying apart. The strap 14 is attached by suit fastening means, e.g. a pop rivet or the like, in one end to a rear side of a rung 8 of the ladder leg 2 and in another end to a rear side of a rung 8 of the ladder leg 3. Preferably, the strap 14 is attached to the rungs 8 positioned on ladder section 4e of the ladder legs 2, 3, respectively, but it would also be possible to attach the strap 14 to rungs associated with ladder sections located above or below ladder sections 4e. The strap 14 is also shown in FIGS. 3 and 5, but has been omitted in FIGS. 1 and 4 for clarity reasons. The strap 14 can be made of nylon woven nylon material.

In FIG. 3 is shown how the hinge connection 5 almost creates a platform between the upper part of the ladder legs 2, 3, that can be used for placing a toolbox or the like or to stand on.

In FIGS. 4 and 5 the ladder section 4d of the ladder leg 2 is collapsed. The stepladder 1 is converted to a straight ladder, which is positioned against a wall. The support part 12 enables the ladder to be leaned against the wall without the ladder leg 2 interfering or instabilizing the ladder in the leaned position. Since the ladder section 4d of the ladder leg 2 is collapsed, the ladder leg 2 is hanging freely and out of the way when the ladder is converted to a straight ladder. Any or several of the collapsible ladder sections 4a-4d can be collapsed. To ensure that the collapsed ladder sections are not extended by its own weight, a holding means 15 holds the collapsed ladder sections and the ladder section positioned adjacently below the collapsed ladder sections together.

In FIG. 4 the holding means is a strap 15 of a nylon material, but it can also be a hook, which is attached to the rung of one ladder section and which can be pivoted so that the hook part is surrounds the rung of an adjacently positioned ladder section. It is also possible to use a U-shaped clamp of a plastic material, which holds the rungs of the collapsed ladder sections and the ladder section positioned adjacently below the collapsed ladder sections together. The advantage with a clamp is that any of the ladder sections 4a-4d can be collapsed and held my the clamp, whereas the location of a hook or a strap decides which collapsible ladder sections 4a-4d should be collapsed and held together with the ladder section positioned adjacently below the collapsed ladder section. According to yet another alternative, the retaining mechanism or more the specifically the locking pins of the retaining mechanism can be used to hold or lock a collapsed collapsible ladder sections 4a-4d in relation to a ladder section positioned adjacently below the collapsed ladder section 4a-4d.

In FIGS. 4 and 5 the ladder section 4d is collapsed and the strap 15, i.e. the holding means, surrounds the collapsed ladder section 4d and the ladder section 4e of the ladder leg 2. The strap 15 is preferably attached to one of the rungs 8, 9 and being long enough to surround the rungs of the collapsed ladder sections and the rung of the ladder section positioned adjacently below the collapsed ladder sections. In the embodiment shown in FIGS. 4 and 5 the strap 15 is attached to rung 9 by a pop rivet or any other suitable fastening means. The strap 15 is fastened by the center of the strap 15 so that the strap extends substantially equally in both directions from the fastening position. In the end parts of the strap 15, Velcro© fasteners or similar fastening means are provided that interacts with each other when the strap ends surround the rungs.

The ladder sections 4b-4e of the ladder leg 3 are suitably designed with deeper rungs 8, 9, 11 (see FIGS. 3 and 5) to provide an extra foot support compared with the rungs of the ladder sections of the ladder leg 2. The rungs are suitably made of an extruded aluminum profile.

In the above embodiment showing the converted ladder, i.e. the use of the ladder as a straight ladder, at least one collapsible ladder section 4a-4d of the first ladder leg 2 is collapsed to enable the ladder to be used as a straight ladder. However, it is also possible to keep all ladder sections 4a-4d of the first ladder leg 2 extended and fold in the ladder leg 2 to be adjacent and parallel to the second ladder leg 3. The holding means 15 can in that case be used to maintain the two ladder legs 2, 3 in the adjacent and parallel position. The lower ladder section 4e of the second ladder leg 3 could in that case be longer than the lower ladder section 4e of the first ladder leg 2 so that both lower end parts of the two ladder legs 2, 3 are supported by the ground at the same time.

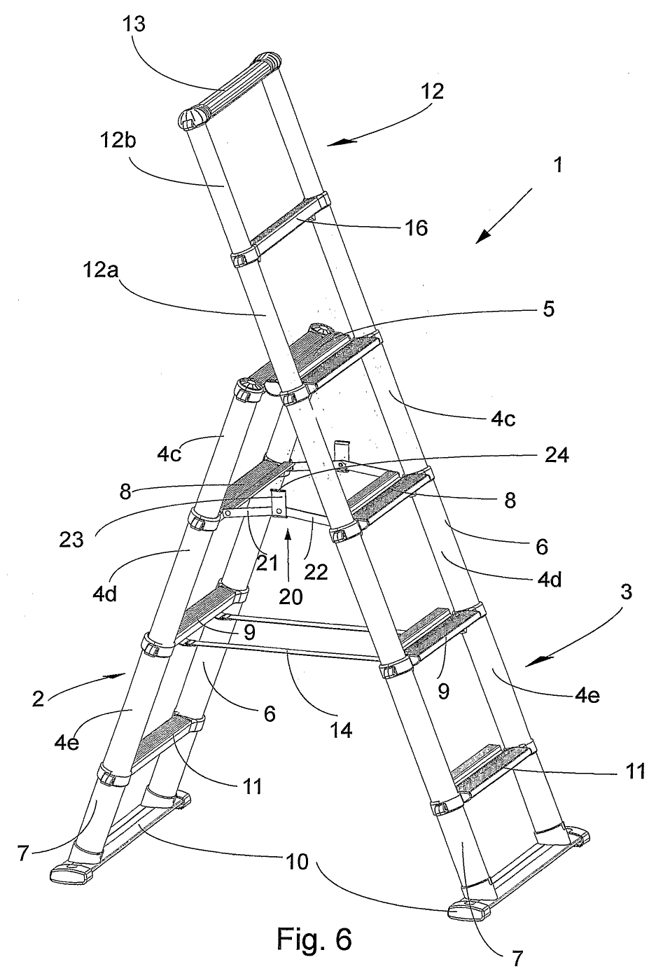

In FIGS. 6-8 the collapsible stepladder shown having fewer collapsible ladder sections is provided with a locking device 20. The locking device 20 comprises a first part 21 and a second part 22. The first part 21 is pivotally connected to a rung 8 of the first ladder leg 2 in one end, preferably the rung 8 of a ladder section located closely below the hinge connection 5. The second part 22 is similarly pivotally connected to a corresponding rung 8 of the second ladder leg 3 in one end, preferably the rung 8 of a ladder section located closely below the hinge connection 5. The other ends of the first and the second parts 21, 22 are lockably and foldably connected to each other. In the connection between the first and the second parts 21, 22 a locking part 23 is also arranged having a handle portion 24 extending upwards.

The locking device 20 serves to secure that the ladder legs 2, 3 of the stepladder 1 are not folded together unintentionally when the stepladder 1 is in use. As the collapsible ladder sections of the stepladder 1 are extended and the fully extended ladder legs 2, 3 are unfolded to the use mode, the first and second part 21, 22 of the locking device 20 are unfolded to constitute an almost straight and horizontal part between the rungs 8 of the corresponding ladder sections of the stepladder 1. By pulling the locking part 23 upwards by the handle portion 24, the first and second part 21, 22 of the locking device 20 are locked in relation to each other by the locking part 23 and any external force of normal magnitude on the stepladder 1 will not result in that the ladder legs 2, 3 are folded together and potentially putting any user using the stepladder 1 in a hazardous position. In FIG. 6 the locking device 20 is in the locked position.

To unlock the locking device 20, the handle portion 24 is pushed downwards thereby moving the ends of the first and second parts 21, 22 of the locking device 20 downwards and enabling the ladder legs 2, 3 to be folded together if so desired.

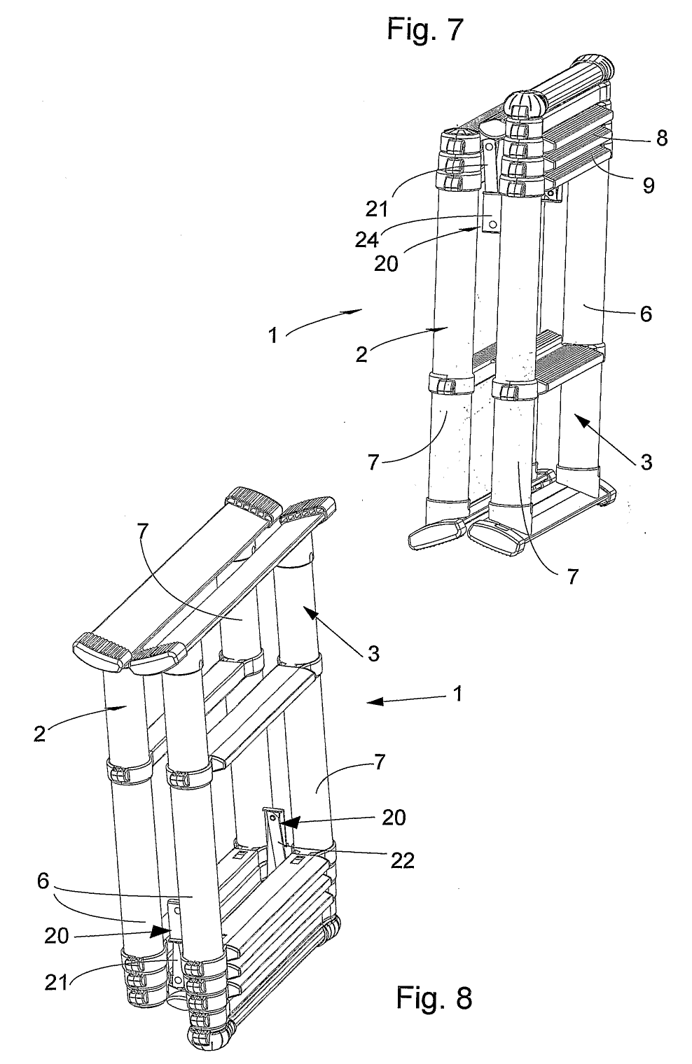

As the locking device 20 in its entirety is arranged inside the ladder bars 6, 7 the locking device 20 is protected from any external forces during handling of the stepladder 1. Moreover, as the first and second parts 21, 22 of the locking device 20 are arranged on a small protruding part of the short ends of the rungs 8, the locking device 20 can be folded without interfering with the telescopically collapsing functionality of the stepladder 1, but the locking device 20 will follow the ladder sections downwards as the ladder sections are collapsed. FIGS. 7 and 8 clearly show that the locking device 20 is arranged inside a space defined by the ladder legs 2, 3, more specifically by the ladder bars 6 or 7 of the ladder legs 2, 3 and the rungs 8 of the ladder sections.

The invention is not limited to the embodiments described above and shown on the drawings, but can be supplemented and modified in any manner within the scope of the invention as defined by the appended claims.

1. A collapsible stepladder (1) comprising a first and a second ladder leg (2, 3), where the legs (2, 3) are hingedly connected to each other in one end, and where each of the ladder legs (2, 3) comprises several ladder sections (4a-4e), and where each section (4a-4d) comprises two ladder bars (6, 7) arranged parallel to each other and interconnected at one end by a rung (8) to form a U-shaped ladder section, furthermore each ladder section (4a-4d) are telescopically inserted into a lower ladder section to form a collapsible ladder comprising at least three ladder sections, where the second ladder leg (3) is provided with a support part (12) in one end, the support part (12) being telescopically extendible from the ladder leg (3) to form an extension ladder of the ladder leg (3), wherein the support part (12) projects above a hinge (5) interconnecting the two ladder legs (2, 3), characterized in that the collapsible stepladder (1) is arranged to be converted to a straight ladder.

2. A collapsible stepladder (1) according to claim 1, wherein the first ladder leg (2) is provided with a holding means (15) to keep one or several collapsible sections (4a-4d) in a collapsed position.

3. A collapsible stepladder (1) according to claim 2, wherein the holding means (15) is a strap or hook attached to one of the ladder sections (4a-4e) of the first ladder leg (2) to hold a collapsed ladder section (4a-4d) together with a ladder section positioned adjacently below the collapsed ladder section (4a-4d).

4. A collapsible stepladder (1) according to claim 2, wherein the holding means (15) is a U-shaped clamp arranged to hold the rungs (8, 9) of a collapsed ladder sections (4a-4d) and the ladder section positioned adjacently below the collapsed ladder section (4a-4d) together.

5. A collapsible stepladder (1) according to claim 1, wherein the collapsible stepladder is arranged to be converted to a straight ladder by means of the hingedly connected ladder legs (2, 3), enabling completely extended ladder legs (2, 3) to be parallelly arranged.

6. A collapsible stepladder (1) according to claim 5, wherein a lower ladder section (4e) of the second ladder leg (3) is longer than the lower ladder section (4e) of the first ladder leg (2).

7. A collapsible stepladder (1) according to any of the preceding claims, wherein the support part (12) comprises at least one collapsible ladder section (12a, 12b, 12c).

8. A collapsible stepladder (1) according to any of the preceding claims, wherein the support part (12) is provided with means to hold tools, paint or other working materials.

9. A collapsible stepladder (1) according to any of the preceding claims, wherein the two ladder legs (2, 3) are connected by a flexible link (14), provided between corresponding ladder sections (4b-4d) of the ladder legs to prevent the ladder legs (2, 3) of the stepladder from splaying apart during use.

10. A collapsible stepladder (1) according to any of the preceding claims, wherein the two ladder legs (2, 3) are connected by a locking device (20), provided between corresponding ladder sections (4b-4d) of the ladder legs to prevent the ladder legs (2, 3) of the stepladder from moving in relation to each other during use.

11. A collapsible stepladder (1) according to claim 10, wherein the locking device (20) is arranged with one end of a first and a second part pivotally attached, respectively, to one side of corresponding rungs of corresponding ladder sections (4b-4d) of the two ladder legs (2, 3), and where the first and second parts are lockably and foldably connected to each other in another end.

12. A collapsible stepladder (1) according to claim 10 or 11, wherein the locking device (20) is arranged to be folded so that the locking device (20) in a folded mode is stored in the space between the ladder legs (2, 3).

13. A collapsible stepladder (1) according to any of the preceding claims, wherein at least one of ladder legs (2, 3) of the stepladder is provided with means (10) for improving lateral stability.

14. A collapsible stepladder (1) according to claim 13, wherein the stabilizing means is a ladder base (10) attached to the lower end of the ladder bars (6, 7) of the lowermost sections (4e) of the ladder leg and extending between the ladder bars.
